(19) United States
(12) Patent Application Publication
(10) Pub. No.: US 2026/0254081 A1
(43) Pub. Date: Aug. 27, 2026

(54) A PHASE SHIFTER CIRCUIT OPERATING AT TERAHERTZ BAND WHICH IS TUNABLE OR RECONFIGURABLE IN ANY WAY

(71) Applicants: TOBB EKONOMI VE TEKNOLOJI UNIVERSITESI, Ankara (TR); YILDIRIM BEYAZIT UNIVERSITESI MUHENDISLIK VE DOGA BILIMLERI FAKULTESI DEKANLIGI, Kecioren/Ankara (TR); ORTA DOGU TEKNIK UNIVERSITESI, Cankaya/Ankara (TR)

(72) Inventors: Mehmet UNLU, Ankara (TR); Asaf Behzat SAHIN, Ankara (TR); Muhammed Abdullah UNUTMAZ, Ankara (TR); Husnu DAL, Çankaya/Ankara (TR); Tugba KEMIKSIZ, Gebze/Kocaeli (TR); Gulay OZSAHIN, Gebze/Kocaeli (TR)

(21) Appl. No.: 18/874,892

(22) PCT Filed: Jun. 14, 2023
(86) PCT No.: PCT/TR2023/050570

§ 371 Date: Dec. 13, 2024

(30) Foreign Application Priority Data
Jun. 14, 2022 (TR) 2022/009844

(51) Int. Cl. H01P 9/00; H01P 1/18

(52) U.S. Cl. CPC H01P 1/184

(57) ABSTRACT

A phase shifter circuit, which creates a delay in a signal by changing the phase of the signal, essentially includes: at least one base; at least one main line made of a conductive material positioned on or within the base and having an input end and an output end for signal input and output; a plurality of gaps for trapping the signal transmitted over the main line; a plurality of conductive parts positioned spaced apart from each other by a certain aperture, switching elements, which are located between each conductive part and the main line, and control the electrical contact of the conductive parts with the main line, and at least one control unit adapted to control the switching elements so as to create a delay in the signal by trapping the signal in the apertures between the conductive parts.

### FIELD OF THE INVENTION

The present invention relates to a phase shifter circuit that can be used in reconfigurable terahertz systems, which is one of the most basic components of 5G and beyond communication, telecommunication systems and all next generation terahertz systems with high resolution imaging and operating with quantum signal processing and optical signal processing logic and requiring these systems. More specifically, the invention relates to a reconfigurable Terahertz Spoof Surface Plasmon Polariton Waveguide (SSPP) circuit which is integrated into cell communication systems, wireless communication, optical signal processing, photonic integrated circuit, high resolution imaging systems and made tunable and able to be tracked by feedback techniques.

### BACKGROUND OF THE INVENTION

Phase shifter circuits are circuits that change the phase of a signal, creating a delay in the said signal and thus slowing down the signals. The said phase shifter circuits can be used for different purposes in many different areas, especially in communication systems. Phase shifter circuits can be implemented in different ways, one of which is Spoof Surface Plasmon Polariton circuits. The Spoof Surface Plasmon Polariton circuits show much higher amplitude performance compared to the other examples operating in terahertz band. Furthermore, compared to the other circuits, circuits developed with Spoof Surface Plasmon Polariton waveguides have an advantage over other components because their phase is also highly dependent on dimensions.

In the state-of-the art applications, Terahertz Spoof Surface Plasmon Polariton circuits are presented as fixed structures. In other words, there are no Terahertz Spoof Surface Plasmon Polariton circuits developed either by electrical or mechanical effects or by a different method.

The United States patent document US2007122155 (A1), a state-of-the-art application, discloses an optical antenna and its internal structure. In this study the antenna structure is comprised of many circuits. The antenna sensing circuit is designed according to plasmon logic. The said circuits can have different patterns and these circuits can operate at different terahertz levels. The phase changes of the said circuit can be provided by the elements (such as diodes, transistors) provided thereon. It is stated that conductive metals (gold, titanium, silver, etc.) and silicon-based semiconductor structures can be selected as structural elements.

The United States patent document US2016233379 (A1), a state-of-the-art application, discloses a chip manufacturing method and construction detail. For plasmon polarization, a circuit structure with opening electron channels and changing the gate sizes for terahertz waves (it was stated that it would be done by using springs or thread pairs) is used. Materials such as gold and titanium are used for metal structures, and gallium silicon and arsenic-based compounds are used for insulators.

Korean patent document KR101103932 (B1), a state-of-the-art application, discloses a circuit operating in plasmonic mode. In this document, an insulating structure is established between two metal layers. By changing the nano-structures in the system, a suitable plasmon system can be created for different modes. Gold is used for metal and silicon-based structures are used for insulating elements.

When the state-of-the-art applications are examined, changing lengths or shapes of the grooves in the waveguide by means of a switching structure in order to provide the delay of the signals is not disclosed.

### OBJECTS OF THE INVENTION

It is an object of the present invention to provide a phase shifter circuit, which, by changing the metal patterns in a waveguide by means of switching elements, enables to create a delay in a signal transmitted through the said waveguide.

Another object of the present invention is to provide a phase shifter circuit that eliminates the problems in current terahertz technologies, which do not operate with high efficiency and many of which have problems with integration.

The phase shifter circuit technology of the present invention can be produced with technologies such as integrated circuit and chip technology. Since the present invention can be produced by reproducible and high-resolution lithography methods, it will be a more advantageous technology than all the technologies that have been produced and developed for commercial or other purposes so far.

### SUMMARY OF THE INVENTION

A phase shifter circuit, which is developed to achieve the objects of the present invention, and is defined in the first claim and the other claims dependent thereon, essentially comprises at least one base; at least one main line made of a conductive material positioned on or within the base and having an input end and an output end for signal input and output; a plurality of gaps for trapping the signal transmitted over the main line; a plurality of conductive parts positioned spaced apart from each other by a certain aperture; switching elements which are located between each conductive part and the main line and control the electrical contact of the conductive parts with the main line; and at least one control unit adapted to control the switching elements so as to create a delay in the signal by trapping the said signal in the apertures between the conductive parts.

There are two different embodiments of the phase shifter circuit of the present invention, wherein, in the first embodiment, grooves extend from at least one of the sides of the main line and gaps are formed between these grooves. In this embodiment of the invention, there is also one conductive part corresponding to each of at least two grooves and a certain aperture between these conductive parts. There is provided a switching element between the said grooves and the conductive parts. The switching elements used in this embodiment of the invention may be an actuator or a switch, such as a NEMS, MEMS, semiconductor or relay actuator or switch. When the said switching elements are controlled by a control unit, the grooves and the conductive parts electrically contact each other and the apertures between the conductive parts are added to the gaps between the grooves, increasing the size of the gap between the grooves where the signal will be trapped. Therefore, the signal transmitted over the main line is slowed down, creating a delay in the said signal.

In another embodiment of the invention, no grooves extend from the sides of the main line. In this embodiment, the gaps where the signal will be trapped are located in the middle part of the main line. Again, in this embodiment, a plurality of conductive parts is used to apply a delay to the signal. While at least some of the said conductive parts extend over the main line, at least one end of these conductive parts touches the base. There are switching elements provided between the said conductive parts and the main line. In this embodiment of the invention, the switching elements may again be NEMS, MEMS, semiconductor or relay actuator or switch. When the said switching elements are controlled by the control unit, the signal passing over the main line is trapped in the gaps between the said conductive parts, thereby slowing down the said signal and thus creating a delay in this signal.

The working principle of the phase shifter circuit of the present invention is based on the ability to change the phase and amplitude characteristics of the terahertz wave transmitted over different patterns created on the metal, depending on the pattern of the said metal. For the integration of the circuits with other circuits, transition regions or transitions that convert the mode of the terahertz wave are used. These transitions are designed to match the phase of the mode transmitted at the input and output with the phase of the Spoofy Surface Plasmon Polariton circuits. The transition regions are designed by giving various patterns to the circuit zones where the continuation of the Spoofy Surface Plasmon Polariton zones is transmitted to the other mode. The dimensions of these circuits or transition regions are optimized.

### DETAILED DESCRIPTION OF THE INVENTION

The phase shifter circuit developed to achieve the objects of the present invention is illustrated in the accompanying figures in which

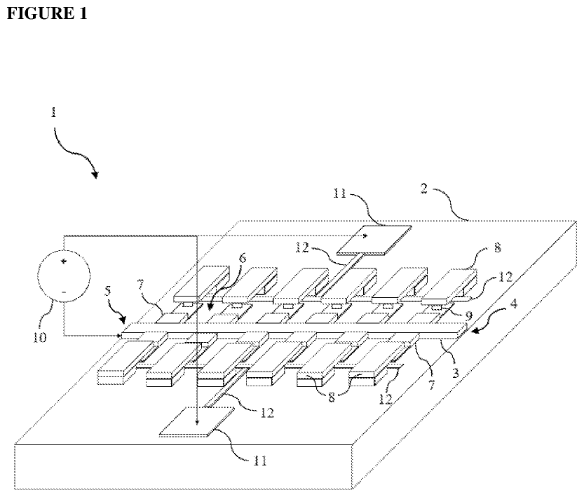

FIG. 1 is a representation of the first embodiment of the phase shifter circuit of the present invention.

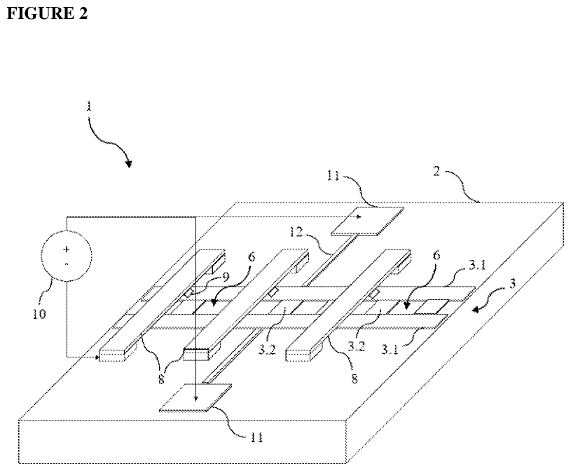

FIG. 2 is a representation of the second embodiment of the phase shifter circuit of the present invention.

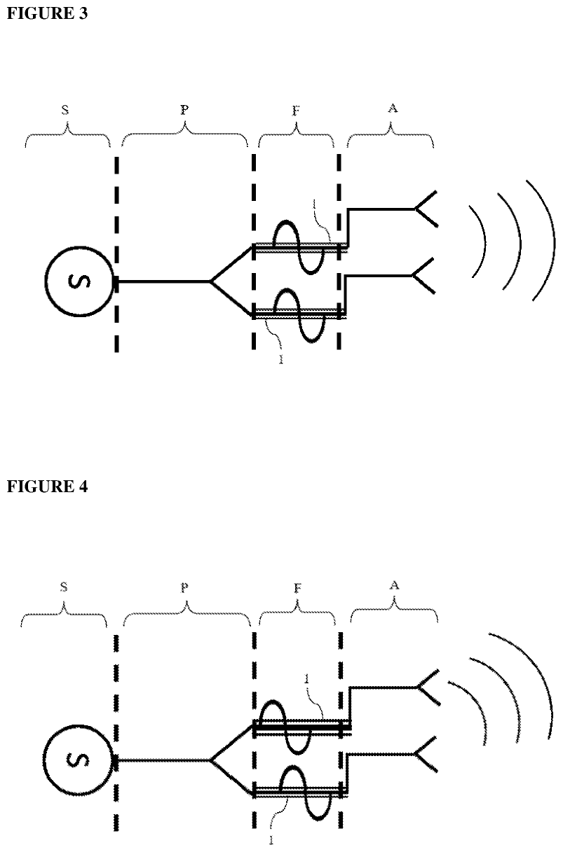

FIG. 3 is a schematic representation of an RF high frequency system.

FIG. 4 is a schematic representation depicting the orientation of the antennas in the system shown in FIG. 3 when signal delay is applied by the upper phase shifter circuit.

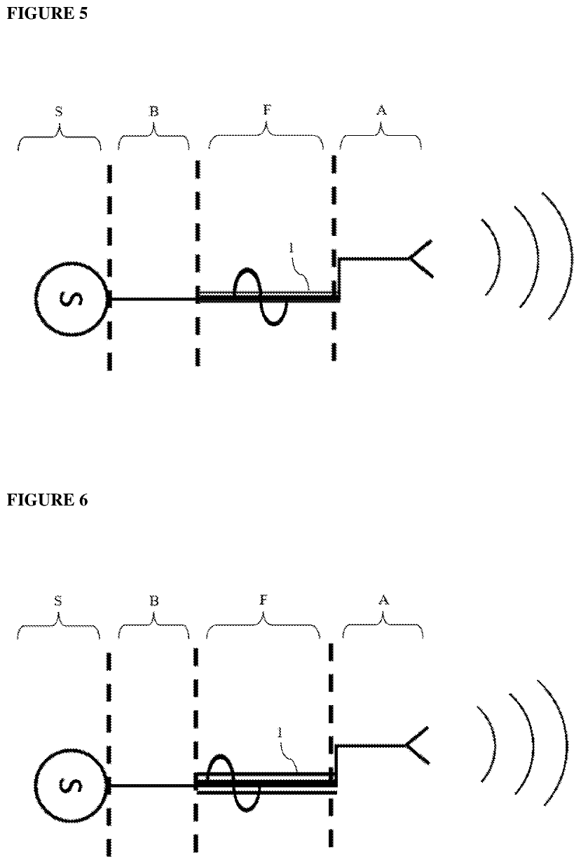

FIG. 5 is a schematic representation of use of the phase shifter circuit in the RF high frequency system comprising a single antenna.

FIG. 6 is a schematic representation of the phase shifter circuit that applied a delay to the signal from the signal source in the circuit of FIG. 5.

The components in the figures are numbered individually and the reference numbers corresponding thereto are given below.
1. Phase shifter circuit
2. Base
3. Main line
   3.1. Branch
   3.2. Connecting piece
4. Input end
5. Output end
6. Gap
7. Groove
8. Conductive part
9. Switching element
10. Control unit
11. Electrical contact point
12. Conductive element
S. Signal source
P. Power divider
B. Feed Line
F. Phase shifting section
A. Antenna

The phase shifter circuit (1) of the present invention, which creates a delay in a signal by changing its phase, essentially comprises;
at least one base (2),
at least one main line (3) made of a conductive material positioned on or within the base (2) and having an input end (4) and an output end (5) for signal input and output,
a plurality of gaps (6) formed on or at the sides of the main line (3) for trapping the signal transmitted over the main line (3),
a plurality of conductive parts (8) positioned spaced apart from each other by a certain aperture,
switching elements (9), which are located between each conductive part (8) and the main line (3), and control the electrical contact of the conductive parts (8) with the main line (3),
at least one control unit (10) adapted to control the switching elements (9) so as to create a delay in the signal by trapping the said signal in the apertures between the conductive parts (8).

The working principle of the phase shifter circuit (1) of the present invention is based on changing the phase of a signal depending on changing the pattern of a metal conductor over which the said signal is transmitted, thereby creating a delay in the said signal. The said process of creating a delay in the signal depends on the size of the medium in which the signal is trapped. In other words, when the size of the medium in which the signal is trapped is increased, a delay can be created in the said signal. In the phase shifter circuit (1) of the present invention, changing the size of the gaps (6), which constitute the signal trapping medium provided in the pattern of the metal conductor that enables the signal to be transmitted, is basically enabled by means of the conductive parts (8), switching elements (9) and the control unit (10) that controls the said switching elements (9).

There are two different embodiments of the invention for changing the phase of the signal. In the first embodiment of the invention, by adjusting the phases of the signals depending on the length change, the sizes of the signal trapping gaps (6) provided in the circuit are adjusted. In the second embodiment of the invention, the phases of the signals are adjusted depending on the shape change, and additionally signal trapping gaps (6) are added to the circuit.

Various embodiments of the above-mentioned phase shifter circuit (1) of the invention are described in detail below.

In the first preferred embodiment of the invention shown in FIG. 1, the phase shifter circuit (1) comprises a base (2), a main line (3) made of a conductive material (e.g., a metal) located on or within the base (2), and grooves (7) extending from the sides of the main line (3).

Said base (2) can be produced from a dielectric material such as glass, silicon and wood. However, the invention is not limited thereto, and a metal material such as gold (Au), silver (Ag), titanium (Ti) or alternatively different filler materials such as silicon (Si), silicon dioxide (SiO2), gallium arsenic (GaAs), gallium nitrate (GaN), aluminum gallium nitrate (AlGaN), aluminum gallium arsenic (AlGaAs), indium phosphate (InP), indium aluminum arsenic (InAlAs) wherein properties such as the atomic ratios and filler material conductivity, resistivity, relative dielectric constant in the components may vary, can also be used.

One end of the main line (3) is the signal input end (4) while the other end is the signal output end (5). The geometric form of the said main line (3) can be flat, or it may have different non-flat forms or patterns (for example, sine waveform pattern, square waveform pattern, triangular waveform pattern, etc.).

Said grooves (7) extend from the sides of the main line (3) in the form of protrusions. The forms of the said grooves (7) can be the same or different from each other. The said grooves (7) can be produced such that the total number and geometric forms thereof will be different according to the need. In one embodiment of the invention, the lengths of these grooves (7) are the same. In another embodiment of the invention, the length of each groove (7) is different from another. In a further embodiment of the invention, the lengths of some grooves (7) are the same, whereas the lengths of other grooves (7) are different from each other. In one embodiment of the invention, the said grooves (7) extend in the form of a comb from only one or both sides of the main line (3) and the geometric forms of these grooves (7) can be the same or different from each other. One embodiment of the invention comprises Spoof Surface Plasmon Polariton waveguide comprising a main line (3) and grooves (7). In one embodiment of the invention, the number of the grooves (7) extending from one side of the main line (3) may be the same as or different from the number of grooves (7) extending from the other side. In one embodiment of the invention, two grooves (7) may be of different forms and may be symmetrical or asymmetrical so as to form at least one gap (6) between them. For example, at least one or all of the said grooves (7) may be in the form of a flat protrusion or in the form of a T.

The form of the gaps (6) between the grooves (7) extending from the said main line (3) is determined by the geometric form of the grooves (7) and the main line (3). Said gaps (6) enable to trap the signal transmitted from the main line (3), so that the propagation of the signal transmitted from the main line (3) to the medium is reduced, thereby reducing or completely preventing the losses in the said signal.

In order to create a delay in the signal, as explained in detail in the following paragraphs, the sizes of the gaps (6) can be adjusted by making the lengths of the grooves (7) in the phase shifter circuit (1) adjustable to be increased or decreased, and thus the physical properties of this line through which the signal is transmitted can be changed. This way, the speed of the signal traveling on this main line (3) can be controlled. When the lengths of the grooves (7) are increased in order to create a delay in the said signal, the size of the gap (6) between two grooves (7) will also increase, thereby creating a delay in the signal transmitted through the main line (3). Conversely, when the lengths of the said grooves (7) are reduced the size of the gap (6) between the two grooves (7) will also be reduced, thereby reducing the delay in the said signal.

Adjustment of the lengths of the said grooves (7) is enabled by additional parts to be connected to the grooves (7) extending from the sides of the main line (3) and the switching structure that can operate at very high frequency. Said additional parts are conductive parts (8) that are made of a conductive material (e.g. a metal). Said switching structure is the switching elements (9) positioned between the conductive parts (8) and the grooves (7).

The number of switching elements (9) to be used in the phase shifter circuit (1) of the invention may vary. In one embodiment of the invention, there may be one switching element (9) between two neighboring grooves (7) and the conductive parts (8) corresponding to each of these grooves (7), while in some embodiments of the invention, there may be a switching element (9) between more than two or all grooves (7) and the conductive parts (8) corresponding to each of these grooves (7). The said switching elements (9) may be located between at least two grooves (7) on only one or both sides of the main line (3) and the conductive parts (8) corresponding to these grooves (7).

The said switching elements (9) can be switches with micro electromechanical (MEMS—Micro Electro Mechanical Systems) or nano-electromechanical (NEMS—Nano Electro Mechanical Systems) technology, which have a switching structure that can operate at very high frequencies and are produced in very small sizes. Electro-mechanical actuators such as MEMS switches or NEMS switches with the said MEMS, NEMS, etc. technologies enable mechanical adjustment of the metal patterns. During this process, metal contact MEMS or NEMS switches can be used, as well as capacitive contact MEMS or NEMS switches. However, the switching elements (9) used in the invention are not limited thereto, but can be of different materials and different models. For example, the said different metal patterns can also be achieved by short-circuiting of the semiconductive components that connect the different metal regions as a result of electrical activation thereof. For this, semiconductive materials, such as diodes, transistors or resistors, or relays, etc., whose electrical properties can be changed by applying an alternating current or voltage at any frequency or a constant current or voltage, can also be used as switching elements (9).

The said switching elements (9) can be switched on and off optically or electrically by a control unit (10). In one embodiment of the invention, the control unit (10) may be a voltage or current source or a controller that controls a voltage or current source (e.g. a microprocessor, microcontroller, Field Programmable Gate Arrays (FPGA), Digital Signal Processor (DSP), etc.). In one embodiment of the invention, there is a DC electrical control point (11) and conductive elements (12) provided on or within the base (2). Thus, the control signal transmitted by the control unit (10) is transmitted to the switching elements (9) via the said electrical contact point (11) and the conductive elements (12), thereby enabling the switching elements (9) to be controlled.

When one or more switching elements (9) are switched on and off by the control unit (10), the grooves (7) and the conductive parts (8) connected to these switching elements (9) are short-circuited to each other by the said switching elements (9). In other words, depending on the type of the switching element (9) used, the grooves (7) and the conductive parts (8) are electrically connected to each other or by moving the conductive parts (8) towards the grooves (7) corresponding to the said conductive parts (8), the said conductive parts (8) are physically brought into contact with the grooves (7). Thus, as the lengths of the grooves (7) extending from the main line (3) increase, the size of the gap (6) between the two grooves (7) will also increase, and therefore, a change will occur in the phase of the signal passing through the said main line (3) creating a delay in the said signal.

In the second preferred embodiment of the invention shown in FIG. 2, in the phase shifter circuit (1) there is provided a base (2) and at least one main line (3) on or within the base (2). The said base (2) may be produced with one of the materials previously mentioned in the first embodiment of the invention.

In this second preferred embodiment of the invention, the main line (3) has a structure extending in two opposite branches (3.1), wherein said branches (3.1) are connected to each other by means of a plurality of conductive connecting pieces (3.2) having a structure similar to the grooves (7). The main line (3) preferably has a flat shape, but the invention is not limited thereto and the main line (3) may also be in forms such as square wave, sine wave, triangular wave. Here, in the middle part of the main line (3), gaps (6) are formed between neighboring connecting pieces (3.2).

The form of the connecting pieces (3.2) provided in the middle part of the main line (3) can be the same or different from each other. The said connecting pieces (3.2) can be produced such that the total number and geometric forms thereof will be different according to the need. In one embodiment of the invention, the lengths of these connecting pieces (3.2) are the same. In another embodiment of the invention, the length of each connecting piece (3.2) is different from another. In a further embodiment of the invention, the lengths of some connecting pieces (3.2) are the same, whereas the lengths of other connecting pieces (3.2) are different from each other. In one embodiment of the invention, two connecting pieces (3.2) may be of different forms and may be symmetrical or asymmetrical so as to form at least one gap (6) between them. For example, at least one or all of the said connecting pieces (3.2) may be in the form of a flat protrusion or in the form of a T.

The form of the gaps (6) between the connecting pieces (3.2) extending from the said main line (3) is determined by the geometric form of the connecting pieces (3.2) and the main line (3). The said gaps (6) enable to trap the signal transmitted between the input end (4) and output end (5) of the main line (3). Thus, the propagation of the signal transmitted from the main line (3) to the medium is reduced, thereby reducing or completely preventing the losses in the said signal.

In this second preferred embodiment of the invention, additional parts and a switching structure that can operate at a very high frequency to be connected to the main line (3) are used in order to create a delay in the said signal. The said additional parts are conductive parts (8) that are made of a conductive material and have two ends. At least some of these conductive parts (8) extend above the main line (3) without contacting the main line (3). In one embodiment of the present invention, these conductive parts (8) extend above the main line (3), preferably perpendicular to the main line (3), and at least one end of these conductive parts (8) contacts the base (2). There is provided a switching element (9) between each conductive part (8) and the main line (3). The number of the switching elements (9) and conductive parts (8) to be used in the phase shifter circuit (1) of the invention may vary.

At least one end of the conductive parts (8) contacts the base (2). In one embodiment where both ends of the conductive parts (8) are in contact with the base (2), the said conductive parts (8) extend above the main line (3) and the said switching element (9) is positioned between a part of the body of the conductive part (8) and the main line (3). In one embodiment where only one end of the conductive parts (8) contacts the base (2), the other end of the conductive parts (8) which is not in contact with the base (2) is located above the main line (3) such that it does not contact the main line (3), and the switching elements (9) are located between said end of the conductive parts (8) which is not in contact with the base (2) and the main line (3), or between a part of the body of the conductive part (8) and the main line (3).

As stated in the aforementioned embodiment, the said switching elements (9) may be switches with micro electromechanical (MEMS—Micro Electro Mechanical Systems) or nano electromechanical (NEMS—Nano Electro Mechanical Systems) technology, semiconductive materials (diodes, transistors, resistors etc.) or relays etc. As mentioned before, the switching elements (9) can be controlled by a control unit (10) optically or electrically via the electrical contact point (11) and conductive elements (12).

When the switching elements (9) located between the conductive parts (8) and the main line (3) in the phase shifter circuit (1) are activated by the control unit (10), the said conductive parts (8) act as a groove (7) electrically in contact with the main line (3). Thus, the gaps (6) between these conductive parts (8) can trap the signal transmitted over the main line (3), thereby creating a delay in the said signal. In another case, when the electrical contact of the said conductive parts (8) with the main line (3) is interrupted by means of the switching elements (9), since the said signal will no longer be trapped by the gaps (6) formed between these conductive parts (8), then the current delay in the said signal will also be reduced.

FIG. 3-6 show the RF high frequency system, which is one of the application areas of the phase shifter circuit (1) of the invention. The said system shown in FIG. 3 comprises a signal source (S), a power divider (P) connected to this signal source (S), two phase shifter circuits (1) provided in a phase shifting section (F) that is connected to the output of the power divider (P), and an antenna (A) connected to the output end (5) of these phase shifter circuits (1). Here, a signal sent from the signal source (S) passes through both phase shifter circuits (1). For example, when both phase shifter circuits (1) shown in FIG. 3 are adjusted to provide the same phase, the propagation of the signal emitted from the antenna (A) connected to the output ends (5) of these phase shifter circuits (1) is forward. However, when the phase shifter circuits (1) shown in FIG. 3 are adjusted to provide different phases, for example, when a signal delay is applied to the signal coming from the signal source (S) by the upper phase shifter circuit (1), the direction of the signal emitted from the antennas (A) connected to the output end (5) of these phase shifter circuits (1) will be as shown in FIG. 4. In FIG. 4, the upper phase shifter circuit (1), which applies a delay to the said signal, is represented by thicker lines compared to the lower phase shifter circuit (1). Thus, without physically rotating the direction of the antennas (A), in other words, while the antennas (A) are physically facing towards a certain point, orientation is made towards the antenna (A) that is connected to the phase shifter circuit (1), which slows down the signal passing through it by applying a signal delay, and the signals coming from that direction are scanned. Therefore, by controlling the delay of the signals fed from the same signal source (S) by the phase shifter circuits (1), the antennas (A) can be oriented.

The use of the said phase shifter circuit (1) with a single antenna (A) system in one embodiment of the invention is shown in FIG. 5 and FIG. 6. In this embodiment of the invention, the phase of the signal emitted from the antenna (A) changes according to the delay provided by a phase shifter circuit (1) connected to a feed line (B). Therefore, the phase shifter circuit (1) of the invention can be used, for example, in PSK (Phase Shift Keying) coding methods, especially in RF integrated circuits (RFIC-Radio Frequency Integrated Circuit). The fact that the phase shifter circuits (1) in FIG. 5 and FIG. 6 provide different delays is represented by changing the thickness of the respective three striped line.

The phase shifter circuit (1) of the invention is not limited to the examples disclosed herein, but can also be used in artificial intelligence and robotics, humanoid or humanoid robotic system which has become the focal point in the recent years, in an adjustable signal processing circuit or in any terahertz imaging system that can be integrated to these systems, in many areas such as 5G and beyond communication technologies, Internet-of-Things, Space Technologies, Defense Industry, Biomedical Industry, Material Characterization Systems, in any system that works with radar system logic, such as biomedical imaging, minesweeping, behind-the-wall imaging systems, test and measurement systems such as Vector Network Analyzer, systems for chemical material characterization, imaging the condition of leaves in the agricultural sector, imaging explosives, firearms, cutting and piercing tools, etc. hidden under clothing, by being integrated to any unit or system block that feeds integrated antennas and processes signals where any modulation process such as phase, amplitude modulation is performed. In these areas, the contribution of the invention to the current technologies will be realized by providing both high bandwidth and high resolution and safer operation.

1. A phase shifter circuit, which creates a delay in a signal by changing the phase of the said signal, comprising:
at least one base;
at least one main line made of a conductive material positioned on or within the base and having an input end and an output end for signal input and output;
a plurality of gaps for trapping the signal transmitted over the main line;
a plurality of conductive parts positioned spaced apart from each other by a certain aperture;
switching elements, which are located between each conductive part and the main line, and control the electrical contact of the conductive parts with the main line; and
at least one control unit adapted to control the switching elements so as to create a delay in the said signal by trapping the said signal in the apertures between the conductive parts.

2. A phase shifter circuit according to claim 1, comprising grooves extending from at least one side of the main line.

3. A phase shifter circuit according to claim 2, comprising gaps formed between the grooves.

4. A phase shifter circuit according to claim 3, wherein the main line and grooves form a Spoof Surface Plasmon Polariton wave guide.

5. A phase shifter circuit according to claim 3, wherein the switching elements, which are located between the grooves extending from at least one side of the main line and the conductive parts corresponding to the said grooves, and which are intended for controlling the electrical contact of the said grooves with the conductive parts.

6. A phase shifter circuit according to claim 1, wherein the main line extends in two opposite branches and comprise comprises a plurality of connecting pieces that enable the said branches to contact each other, and wherein in the middle part thereof gaps are formed between neighboring connecting pieces.

7. A phase shifter circuit according to claim 6, wherein at least a part of the conductive parts extends above the main line and at least one end of which contacts the base.

8. A phase shifter circuit according to claim 1, wherein the switching elements are switches selected from a group of switches consisting of MEMS, NEMS, semiconductor or and relay switches.

9. A phase shifter circuit according to claim 1, wherein the control unit is a voltage or current source or a controller that controls a voltage or current source.

10. A phase shifter circuit according to claim 1, comprising an electrical control point and conductive elements which are located on or within the base to enable the switching elements to be controlled by the control unit.

11. A phase shifter circuit according to claim 1, wherein the main line has a geometric form selected from a group consisting of straight, square wave, sine wave and triangular wave forms.
